(19) United States
(12) Patent Application Publication
(10) Pub. No.: US 2017/0020079 A1
(43) Pub. Date: Jan. 26, 2017

(54) PORTABLE BLOWER WITH ATTACHMENT CLIP

(71) Applicant: Roger L. Rhodes, Kennesaw, GA (US)

(72) Inventor: Roger L. Rhodes, Kennesaw, GA (US)

(21) Appl. No.: 15/218,431

(22) Filed: Jul. 25, 2016

Related U.S. Application Data
(60) Provisional application No. 62/196,069, filed on Jul. 23, 2015.

(51) Int. Cl. A01G 1/12; A63B 57/50; F04D 25/08; F04D 19/00; F04D 25/06

(52) U.S. Cl. CPC A01G 1/125; F04D 19/002; F04D 25/0673; F04D 25/08; A63B 57/50

(57) ABSTRACT

A portable blower is suitable for blowing leaves and debris. The blower includes a housing defining a handle, a battery compartment, and a motor housing. A DC motor with an output shaft is disposed in the motor housing, and a fan blade is connected to the output shaft.

### CROSS-REFERENCES TO RELATED APPLICATIONS

This application claims the benefit of U.S. Provisional Patent Application No. 62/196,069, filed Jul. 23, 2015, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to a portable blower and, more particularly, to a portable blower that is compact, versatile and multi-functional.

There are numerous blowers on the market and in patent literature that are suitable for clearing debris from decks, patios, walkways, driveways, golf courses and the like. Existing blowers, however, typically use flywheels rather than axial fans, or if axial fans are used, the fans are disposed inside a tube or housing. These structural components make the existing devices larger and/or less effective in air movement.

### BRIEF SUMMARY OF THE INVENTION

The portable blower according to the described embodiments is suitable for blowing leaves and debris from decks, patios, walkways, driveways and the like. The portable nature of the blower also enables the blower to be readily stowed in a golf bag or the like for clearing leaves and debris from golf greens and other areas to aid a golfer in putting the golf ball, clearing the tee box, finding a lost ball or the like. The blower includes a grip, battery housing, motor housing and axial fan. The self-contained unit can be used by holding the handle or grip, and it is also provided with a groove or tube to accept an extension shaft such as a golf club or the like to enable greater reach or more comfortable use in a standing position. A switch when activated provides current from the batteries to the motor, which turns the fan resulting in air flow to be directed by the operator.

In an exemplary embodiment, a portable blower includes a housing defining a handle, a battery compartment, and a motor housing; batteries disposed in the battery compartment; and a DC motor disposed in the motor housing and having an output shaft. The DC motor is electrically connected with the batteries via a power switch. A fan blade is connected to the output shaft. The DC motor is configured for speeds between 8,000-50,000 rpm, and an output of the batteries is between 12-30 volts.

A shroud cover may be secured to the housing and surrounding the fan blade. The housing may also include a connector tube on an exterior surface that is sized to receive an extension shaft. The connector tube may be integral with the housing and may be disposed adjacent the motor housing. The housing may also include a connector guide disposed spaced from the connector tube that is sized to receive the extension shaft in a snap fit. The housing may be constructed from a left side body and a right side body secured together with at least one connector, where the left and right side bodies are formed of molded plastic. The housing may include a clip disposed at an end thereof opposite from the motor housing. The clip may be integral with a cover for the battery compartment. The motor housing may be pitched at an angle relative to the handle. The portable blower may be operable without a flywheel and without enclosing the fan blade in a tube.

In another exemplary embodiment, a portable blower includes a housing defining a handle, a battery compartment disposed inside the handle, and a motor housing; and a DC motor disposed in the motor housing and having an output shaft. The DC motor is electrically connectable with the battery compartment via a power switch. A fan blade is connected to the output shaft, and a connector tube is disposed on an exterior surface of the housing. A clip is disposed at an end of the housing opposite from the motor housing.

### BRIEF DESCRIPTION OF THE DRAWINGS

These and other aspects and advantages will be described in detail with reference to the accompanying drawings, in which:

FIGS. 1 and 2 are perspective views of the portable blower;

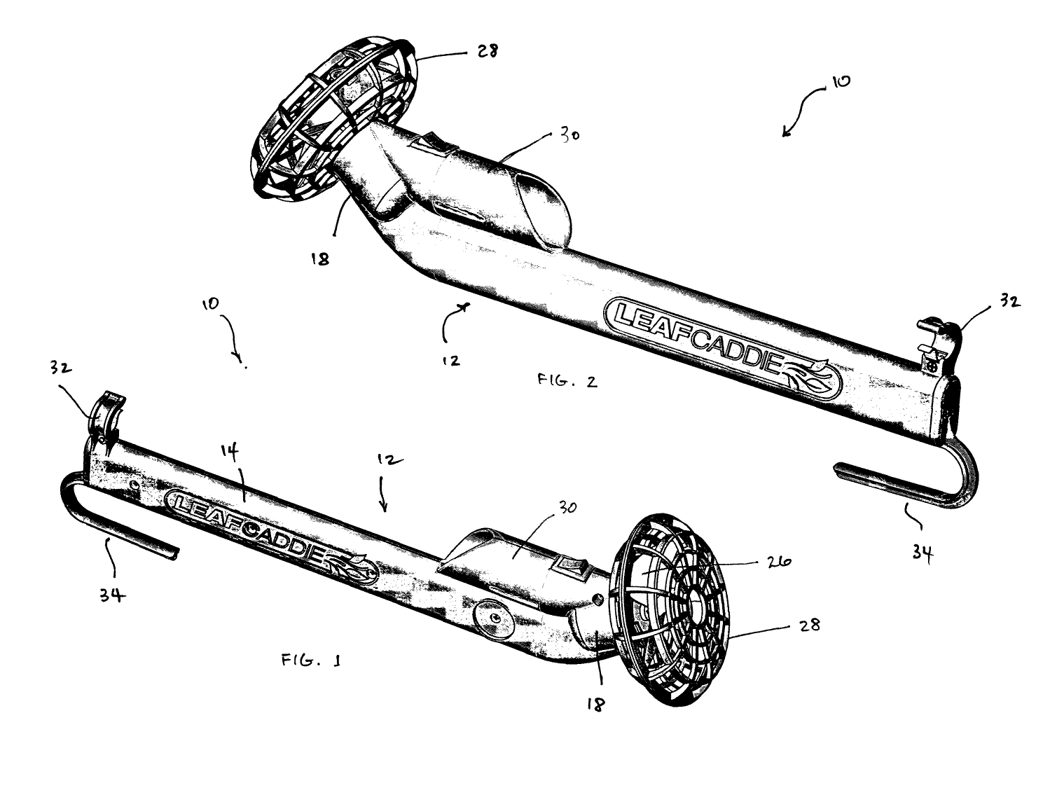

FIGS. 3 and 4 are opposite sectional views showing the internal construction of the portable blower; and

FIG. 5 is an exploded view showing the blower components.

### DETAILED DESCRIPTION OF THE INVENTION

With reference to the drawings, a portable blower 10 includes a housing 12 defining a handle 14, a battery compartment 16 and a motor housing 18. Batteries 20 are insertable into the battery compartment 16, and a DC motor 21 with an output shaft 22 is disposed in the motor housing 18. The motor 21 is electrically connected with the battery compartment 16/batteries 20 via a power switch assembly 24. A fan blade 26 is connected to the output shaft 22 of the motor 21. In some embodiments, a shroud cover 28 may be secured to the housing 12 and disposed surrounding the fan blade 26. The shroud cover 28 serves to protect the blade 26 from impact with exterior objects.

As shown, the motor housing 18 may be pitched at an angle relative to the handle 14. In this manner, since in some embodiments the fan blade 26 is connected directly to the motor output shaft 22, the angle of the motor housing 18 can facilitate operator positioning and control of the rotating fan blade 26.

The housing 12 may be provided with a connector tube 30 that is sized to receive an extension shaft such as a pole or a golf club shaft. The extension shaft may be inserted into the connector tube 30 directly or may be threaded into the connector tube 30. A connector guide 32 may be cooperable with the connector tube 30 and spaced from the connector tube 30 to receive the extension shaft in a snap fit or the like. The connector tube 30 and the connector guide 32 together provide a secure connection for the extension shaft. As shown, the connector tube 30 is disposed adjacent the motor housing 18. The connector guide 32 may be disposed at an opposite end of the housing 12.

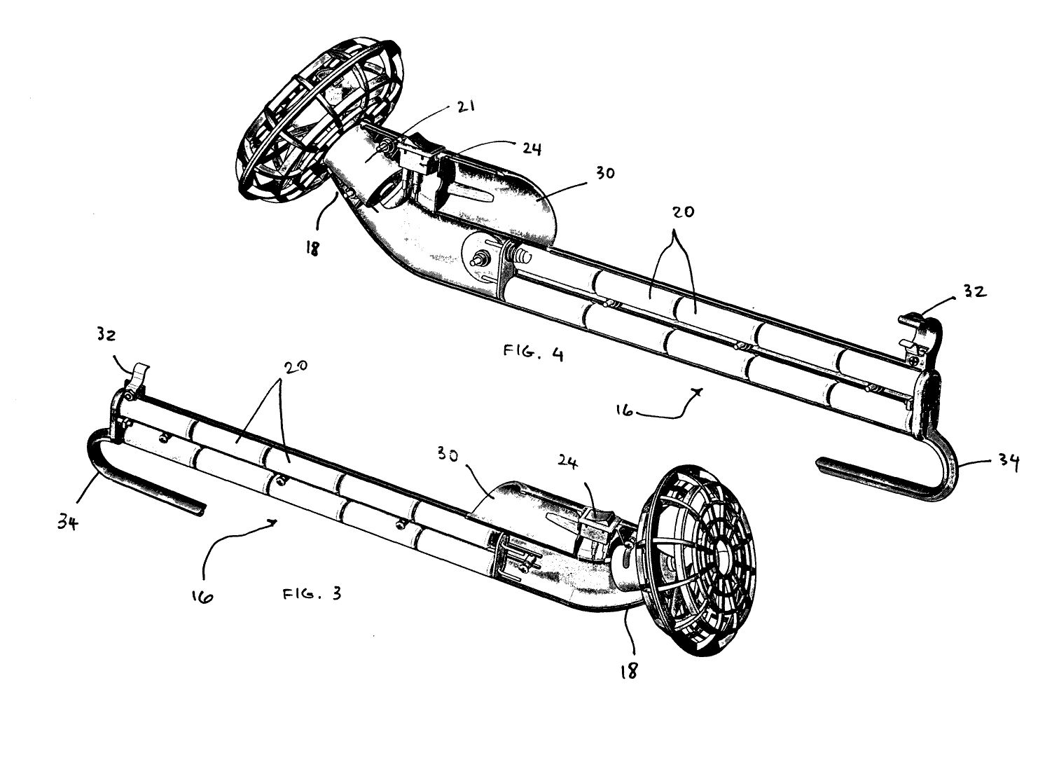

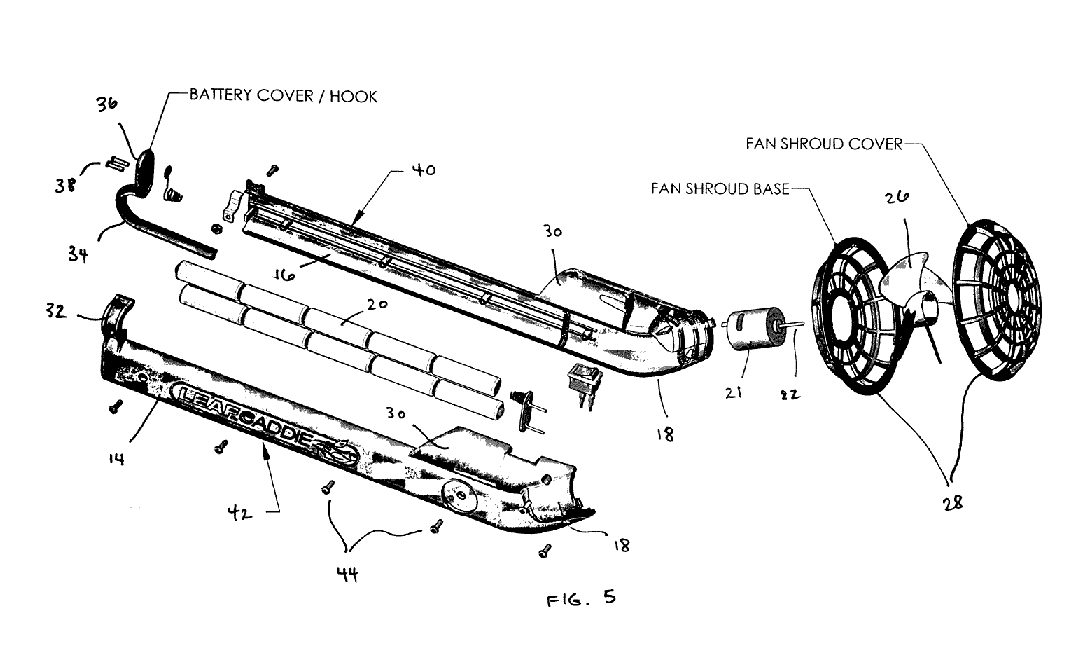

The housing 12 may also include a clip 34 preferably disposed at an end thereof opposite from the motor housing 18. The clip 34 enables the portable blower 10 to be secured to a work belt, golf bag or the like. As shown in FIGS. 3-5, the clip 34 may be integral with a cover 36 for the battery compartment 16. Because the battery compartment cover 36 is secured directly to the housing 12 using independent connectors 38, the clip 34 can be more securely attached to the housing 12.

With reference to FIGS. 3-5, in some embodiments, the housing 12 is made up of a left side body 40 and a right side body 42 secured together using one or more suitable connectors 44 or secured in a snap fit. Exemplary connectors may include screw, straps, clips, glue, sonic welding, and the like. The left and right side bodies 40, 42 may be formed of molded plastic. As shown, the connector tube 30 and the connector guide 32 may be integral with the housing 12.

The motor 21 is preferably configured for operation at speeds between 8000-50,000 rpm. An output of the batteries may be between 12-30 volts, and the fan blade size may be between 2-5 inches.

The portable blower of the preferred embodiments is small and lightweight compared to other fans used for blowing/clearing leaves or debris. As noted, existing fans typically use flywheels rather than axial fans, or when axial fans are used, they are disposed inside of a tube. The typical use of flywheels for leaf blowers and the like adds substantial size and weight to the blower. The lack of a tube in the described design greatly helps air flow. Specifically, the tubes/channels in conventional devices can reduce air flow and/or air speed and/or air volume. The present design without a tube/channel maximizes air flow output speed and power (and effectiveness). The described design is also very powerful compared to small hand-held personal fans used for personal cooling.

The described portable blower incorporates a housing that serves as a grip with a battery compartment and a section for the motor housing. The grip may be held in an operator's hand, or the housing can receive an extension shaft such as a pole or the handle of a golf club. In some embodiments, the fan blade attaches directly to the motor shaft. A switch on the housing controls the circuit that provides energy to the motor. When in use, the user holds the device near the ground in an effective way to direct the air flow to clear leaves and debris.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A portable blower comprising:
a housing defining a handle, a battery compartment, and a motor housing;
batteries disposed in the battery compartment;
a DC motor disposed in the motor housing and having an output shaft, the DC motor being electrically connected with the batteries via a power switch; and
a fan blade connected to the output shaft,
wherein the DC motor is configured for speeds between 8,000-50,000 rpm, and wherein an output of the batteries is between 12-30 volts.

2. A portable blower according to claim 1, further comprising a shroud cover secured to the housing and surrounding the fan blade.

3. A portable blower according to claim 1, wherein the housing comprises a connector tube on an exterior surface, the connector tube being sized to receive an extension shaft.

4. A portable blower according to claim 3, wherein the connector tube is integral with the housing.

5. A portable blower according to claim 4, wherein the connector tube is disposed adjacent the motor housing.

6. A portable blower according to claim 3, wherein the housing comprises a connector guide disposed spaced from the connector tube, the connector guide being sized to receive the extension shaft in a snap fit.

7. A portable blower according to claim 1, wherein the housing comprises a left side body and a right side body secured together with at least one connector, the left and right side bodies being formed of molded plastic.

8. A portable blower according to claim 1, wherein the housing comprises a clip disposed at an end thereof opposite from the motor housing.

9. A portable blower according to claim 8, wherein the clip is integral with a cover for the battery compartment.

10. A portable blower according to claim 1, wherein the motor housing is pitched at an angle relative to the handle.

11. A portable blower according to claim 1, wherein the portable blower is operable without a flywheel and without enclosing the fan blade in a tube.

12. A portable blower comprising:
a housing defining a handle, a battery compartment disposed inside the handle, and a motor housing;
a DC motor disposed in the motor housing and having an output shaft, the DC motor being electrically connectable with the battery compartment via a power switch;
a fan blade connected to the output shaft;
a connector tube disposed on an exterior surface of the housing, the connector tube being sized to receive an extension shaft; and
a clip disposed at an end of the housing opposite from the motor housing.

13. A portable blower according to claim 12, wherein the connector tube is integral with the housing.

14. A portable blower according to claim 13, wherein the connector tube is disposed adjacent the motor housing.

15. A portable blower according to claim 12, wherein the housing comprises a connector guide disposed spaced from the connector tube, the connector guide being sized to receive the extension shaft in a snap fit.

16. A portable blower according to claim 12, wherein the housing comprises a left side body and a right side body secured together with at least one connector, the left and right side bodies being formed of molded plastic.

17. A portable blower according to claim 12, wherein the clip is integral with a cover for the battery compartment.

18. A portable blower according to claim 12, wherein the motor housing is pitched at an angle relative to the handle.

19. A portable blower according to claim 12, wherein the portable blower is operable without a flywheel and without enclosing the fan blade in a tube.
